(19) United States
(12) Patent Application Publication
(10) Pub. No.: US 2015/0136040 A1
(43) Pub. Date: May 21, 2015

(54) Edible Spinning Top for Domesticated Animals

(71) Applicant: Amanda E. Hutton, Lantana, FL (US)

(72) Inventor: Amanda E. Hutton, Lantana, FL (US)

(21) Appl. No.: 14/543,889

(22) Filed: Nov. 17, 2014

Related U.S. Application Data
(60) Provisional application No. 61/904,954, filed on Nov. 15, 2013.

(51) Int. Cl. A01K 11/00; A63H 1/00

(52) U.S. Cl. CPC A01K 15/026; A63H 1/00
USPC 119/709

(57) ABSTRACT

An edible spinning top for domesticated animals is designed to be an interactive treat for a dog, a cat, or any other kind of domesticated animal. The edible spinning top includes a spindle, a body, and a pointed protrusion. The spindle allows a user to initiate the rapid rotation of the body. In addition, the body allows the edible spinning top to maintain its rotational inertia. The pointed protrusion allows the edible spinning top to rotate upon a contact surface with minimal friction. The spindle, the body, and the pointed protrusion are made of an edible, desiccated, and brittle composition so that the edible spinning top can be rotated, can interact with a domesticated animal, and can be consumed by the domesticated animal.

The current application is a non-provisional application and claims a priority to the U.S. provisional patent application Ser. No. 61/904,954 filed on Nov. 15, 2013. The current application is filed on Nov. 17, 2014 while Nov. 15, 2014 was on a weekend.

### FIELD OF THE INVENTION

The present invention relates generally to edible treats for dogs. More specifically, the present invention relates to an edible treat toy for dogs that can also act as an amusement toy before consuming.

### BACKGROUND OF THE INVENTION

As dogs have been domesticated to actively live with humans and interact with them daily, humans have continually found ways to entertain, train, and reward dogs in multiple different environments. During many instances, dog owners often train dogs to perform tricks or tasks, and offer them rewards for their accuracy or execution of such trick or task. In the study of psychology, “Pavlov's Dog” theory of classical conditioning famously experimented with dogs to test their behaviors using a stimulus and a response associated with the presentation of food. While this psychological theory may translate to the habits of other animals, this theory can also explain the common reward for completing a task process that dog owners often go through and have been customizing over recent time.

The present invention is an edible treat toy for dogs. The present invention can initially act as a form of entertainment for the dog, and is intended to be act as a treat or reward for the dog. The present invention contains a spindle component and a shaped body that comes to a point. The present invention works similarly to a child's toy top, but comes in the form of an edible treat for dogs to consume. Using the spindle component of the present invention, the user may twirl the present invention to entertain or train the dog and to eventually allow the dog to bite and eat the treat.

### BRIEF DESCRIPTION OF THE DRAWINGS

FIG. 1 is a top perspective view of the saucer embodiment for the present invention.

FIG. 2 is a side view of the saucer embodiment for the present invention.

FIG. 3 is a cross-sectional view of the saucer embodiment for the present invention, wherein the cross-sectional view is taken along line A-A in FIG. 2.

FIG. 4 is a bottom perspective view of the saucer embodiment for the present invention.

FIG. 5 is an illustration of the present invention being used with a domesticated animal.

FIG. 6 is a top perspective view of the acorn-shaped embodiment for the present invention.

FIG. 7 is a side view of the acorn-shaped embodiment for the present invention.

FIG. 8 is a bottom perspective view of the acorn-shaped embodiment for the present invention.

FIG. 9 is a top perspective view of the heart-shaped embodiment for the present invention.

FIG. 10 is a side view of the heart-shaped embodiment for the present invention.

FIG. 11 is a bottom perspective view of the heart-shaped embodiment for the present invention.

FIG. 12 is a top perspective view of the spiral-shaped embodiment for the present invention.

FIG. 13 is a side view of the spiral -shaped embodiment for the present invention.

FIG. 14 is a bottom perspective view of the spiral -shaped embodiment for the present invention.

### DETAILED DESCRIPTION OF THE INVENTION

All illustrations of the drawings are for the purpose of describing selected versions of the present invention and are not intended to limit the scope of the present invention.

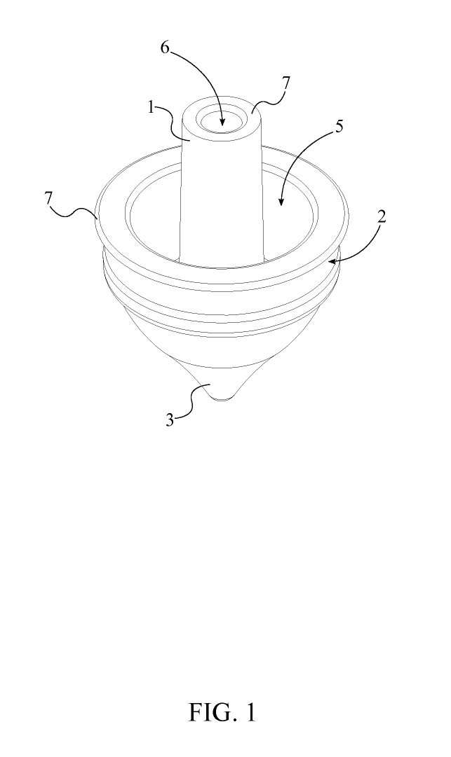

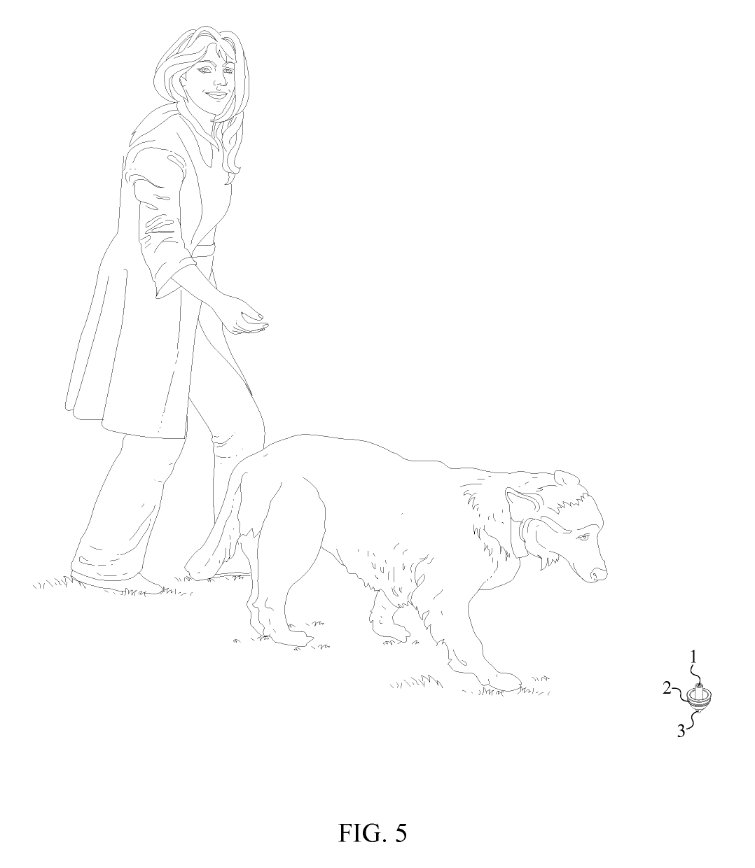

As can be seen in FIGS. 1 and 5, the present invention is an edible spinning top for domesticated animals. The present invention is a kind of edible treat for a dog, a cat, or some other domesticated animal, wherein that edible treat is spun in front of the domesticated animal in order to garner their attention. Consequently, the domesticated animal will be amused by the rapid rotation of the present invention and will proceed to interact and to consume the present invention. The present invention comprises a spindle 1, a body 2, a pointed protrusion 3. The spindle 1 is a shaft protruding from the body 2 that allows a user to grasp and twirl the present invention in order to initiate the rapid rotational motion of the present invention. The body 2 is used to maintain the inertia of the rapid rotational motion of the present invention. The pointed protrusion 3 is a tip extending from the body 2 that allows the present invention to spin upon a surface with minimal friction. The spindle 1, the body 2, and the pointed protrusion 3 are made of an edible, desiccated, and brittle composition. This composition needs to be edible so that no ill health-effects overcome a domesticated animal after consuming the present invention. This composition also needs to be desiccated so that the present invention does not become deformed after spending some time in storage. The prefabricated shape of the present invention is important to maintain because the prefabricated shape allows the present invention to rotate for a longer period of time. Finally, this composition needs to be brittle so that the present invention is rigid enough to be able to rotate about its pointed protrusion 3 yet is crumbly enough to break apart within the domesticated animal's mouth.

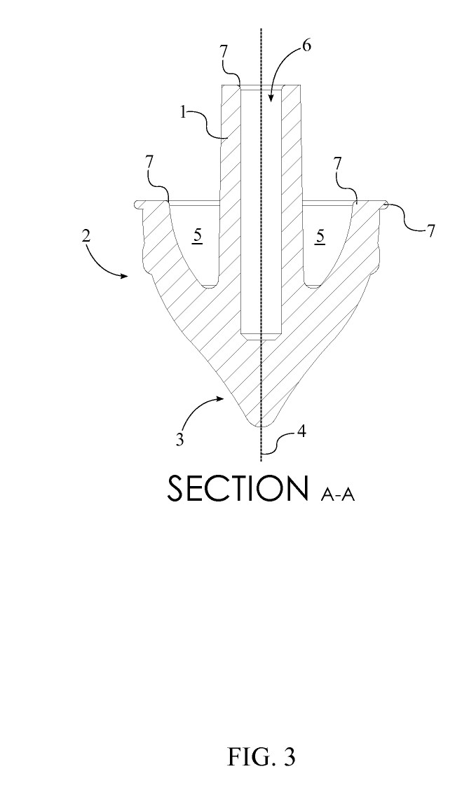

The general configuration of the present invention allows its components to spin about a central axis 4, which is shown in FIG. 3. The body 2 is radially symmetric about the central axis 4 so that the present invention can better maintain its angular momentum about the central axis 4. The spindle 1 is connected adjacent to the body 2, which allows the user to generate and transfer the rotational motion from the spindle 1 into the body 2. The pointed protrusion 3 is connected adjacent to the body 2, opposite to the spindle 1, which allows the user to press and spin the pointed protrusion 3 against a contact surface such as the floor or the ground. Both the spindle 1 and the pointed protrusion 3 are positioned along the central axis 4 so that weight of the present invention is evenly distributed about the central axis 4 allowing the present invention to uniformly spin about the central axis 4.

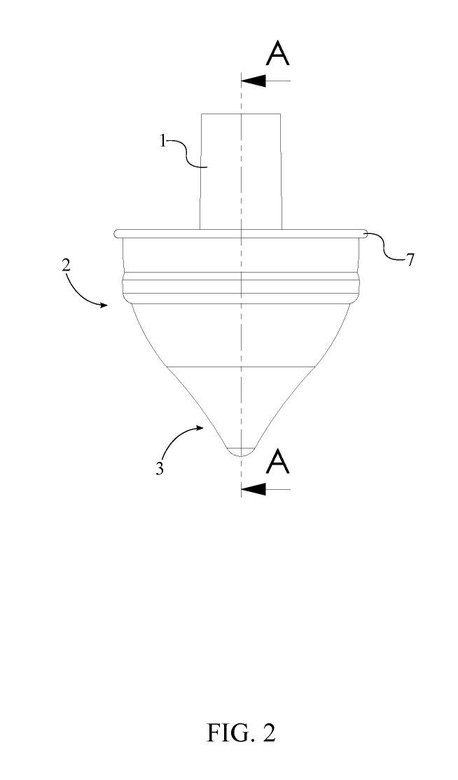

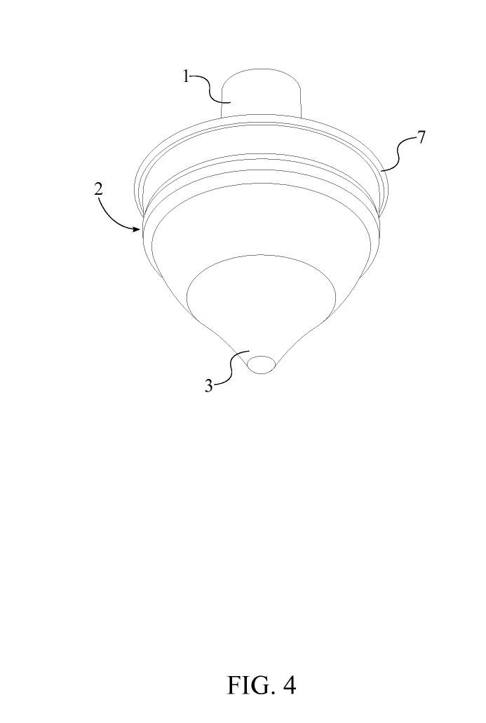

In one embodiment illustrated in FIG. 1 through 4, the present invention is configured with a saucer design, which reduces some of the material needed to manufacture the present invention without minimizing its aesthetic appeal. In addition, this embodiment allows the user to spin the present invention at a faster angular velocity and for a longer period of time. This embodiment comprises an annular cavity 5 and a hollowing cavity 6. The annular cavity 5 removes a section of the body 2 and, thus, traverses into the body 2, opposite to the pointed protrusion 3. The annular cavity 5 is also positioned about the spindle 1 so that the weight removed by the annular cavity 5 is evenly distributed about the central axis 4. The hollowing cavity 6 is a hole located along the central axis 4 and, thus, traverses through the spindle 1 and into the body 2. Similarly, the hollowing cavity 6 is concentrically positioned with the spindle 1 so that the weight removed by the hollowing cavity 6 is evenly distributed about the second axis.

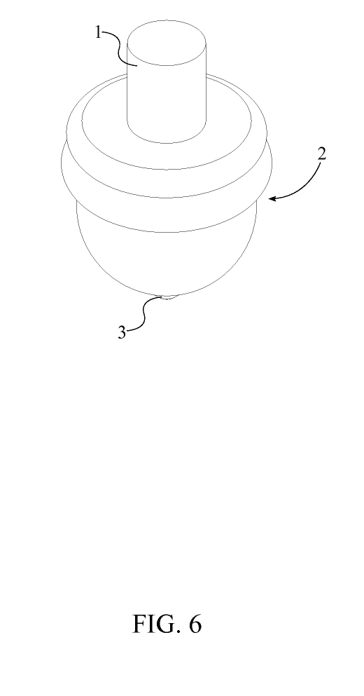

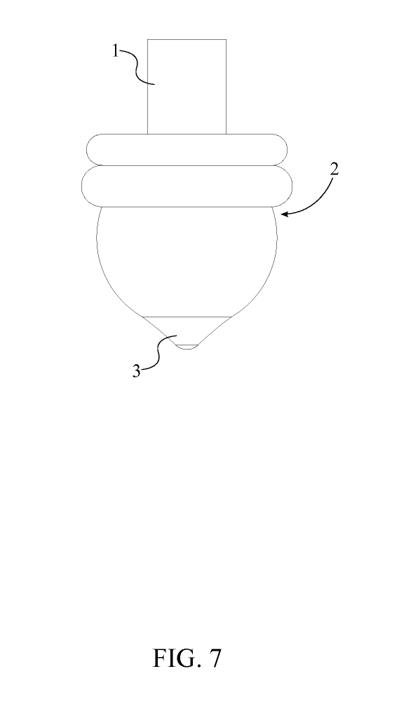

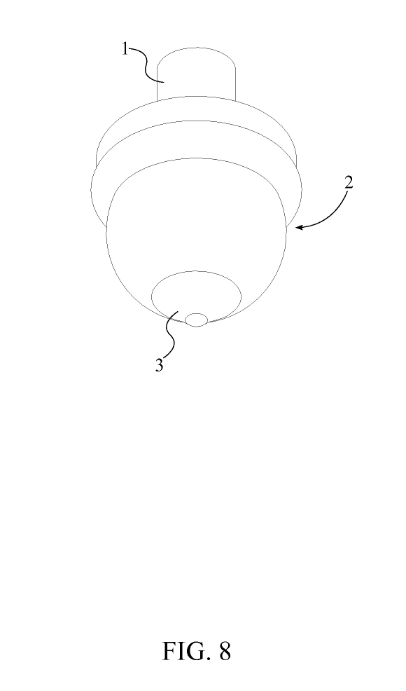

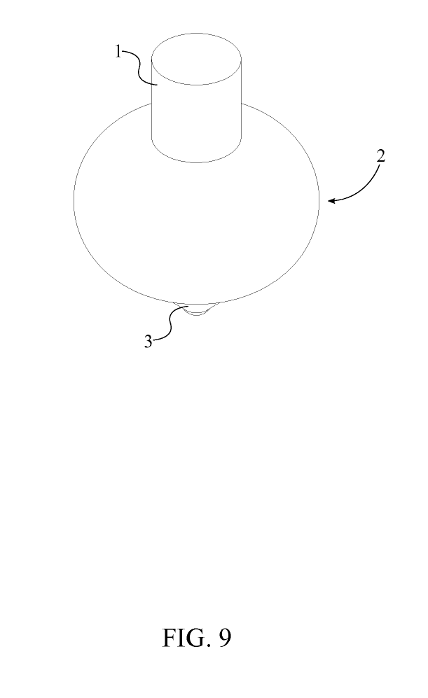

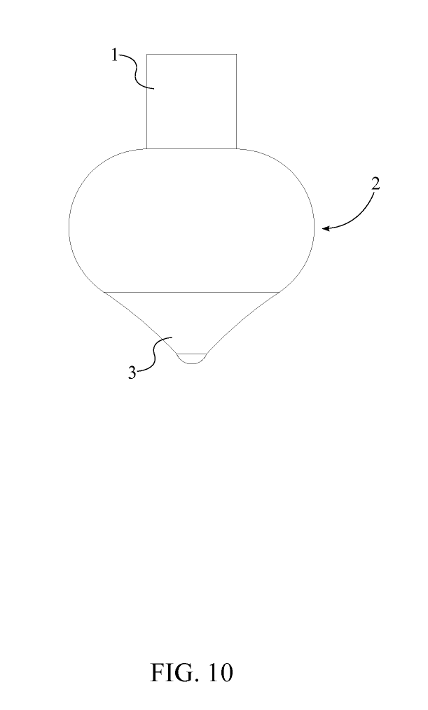

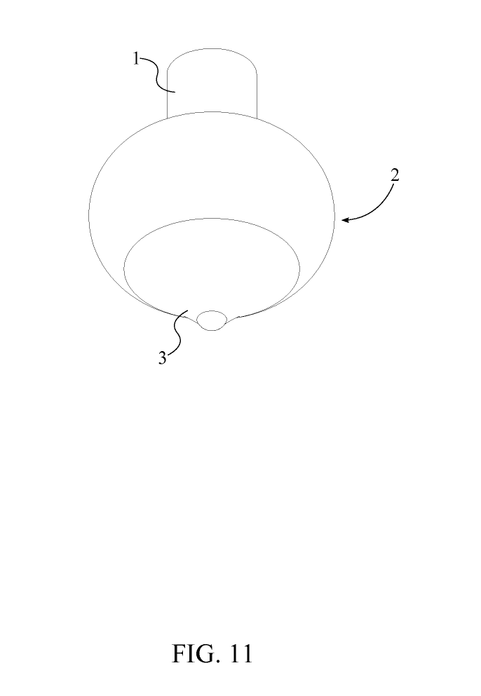

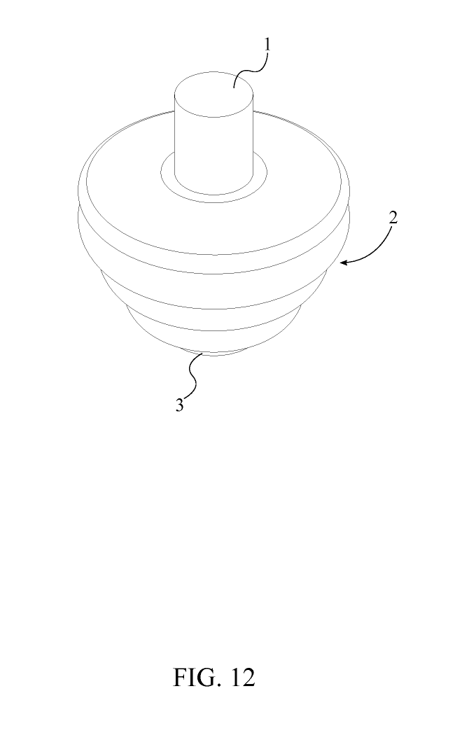

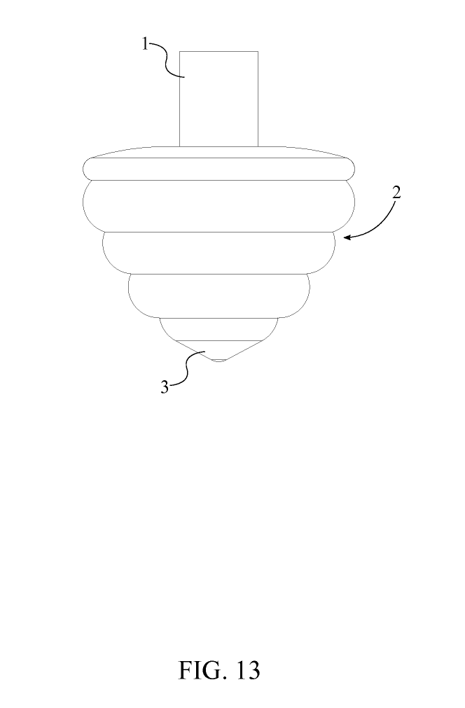

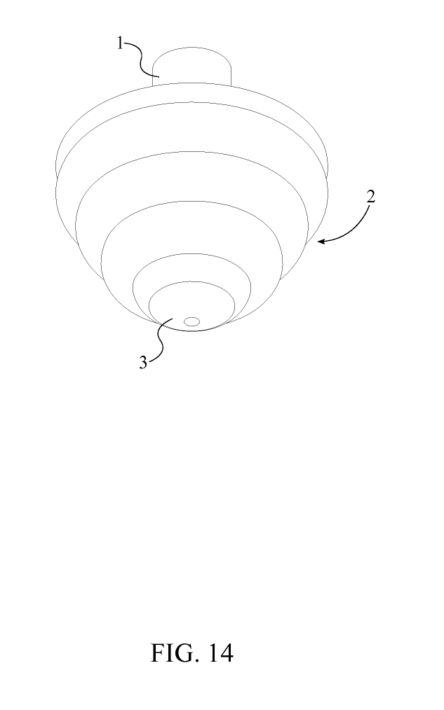

Moreover, the present invention can be made into different designs, shapes, and sizes. In another embodiment, the present invention is configured with an acorn design, which is illustrated in FIGS. 6, 7, and 8. In yet another embodiment, the present invention is configured with a heart design, which is illustrated in FIGS. 9, 10, and 11. In yet another embodiment, the present invention is configured with a spiral design, which is illustrated in FIGS. 12, 13, and 14. Such different designs may appeal to different groups of dogs or dog owners based on their preference. The present invention may also be produced in different sizes to accommodate different sizes of dogs.

As can be seen in FIGS. 1 and 3, the present invention implements a number of features that allow a domesticated animal to safely consume and ingest the present invention. One such feature is that the pointed protrusion 3 is configured as a blunted tip, which prevents the present invention from lacerating the mouth of the domesticated animal with the pointed protrusion 3. Another such feature is that the edges of the body 2 and the spindle 1 are not sharp but rounded, which again prevents the present invention from lacerating the mouth of the domesticated animal.

The edible, desiccated, and brittle composition for the present invention can be made using a variety of standard food baking ingredients through a number of different baking methods. In the preferred embodiment of the present invention, the edible, desiccated, and brittle composition includes, but is not limited to, the following ingredients: flour (preferably organic); water; egg; cinnamon and molasses (either depending on the flavor); peanut butter and honey; beef broth and cheese; chicken broth and parsley; and a combination thereof.

A method of using the present invention for a domesticated animal is described in the following steps. First, the user identifies the current location of the domesticated animal, which allows the user to spin the present invention in the general vicinity of the domesticated animal. Next, the user grasps and twists the spindle 1 into a cocked position for the present invention so that the user can readily let go and spin the present invention. Then, the user rapidly rotates the present invention by releasing the spindle 1 from the cocked position, which should garner the attention of the domesticated animal. The present invention can be directed in two ways while being released by the user: one way is to direct the edible spinning top towards the current location of the domesticated animal; and the other way is to direct the edible spinning top away from the current location of the domesticated animal. Finally, the domesticated animal is alerted to interact and consume the present invention as the present invention is rotating about its central axis 4. One manner in which a domesticated animal may interact with the present invention is that the domesticated animal will either nudge or swat at the present invention as the present invention is spinning. Consequently, the present invention will move away from the domesticated animal so that the domesticated animal can chase down the present invention in order to consume it.

Although the invention has been explained in relation to its preferred embodiment, it is to be understood that many other possible modifications and variations can be made without departing from the spirit and scope of the invention as hereinafter claimed.

What is claimed is:

1. An edible spinning top for domesticated animals comprises:
a spindle;
a body;
a pointed protrusion;
said body being radial symmetric about a central axis;
said spindle being connected adjacent to said body;
said pointed protrusion being connected adjacent to said body, opposite to said spindle;
said spindle and said pointed protrusion being positioned along said central axis; and
said spindle, said body, and said pointed protrusion being made of an edible, desiccated, and brittle composition.

2. The edible spinning top for domesticated animals as claimed in claim 1 comprises:
an annular cavity;
said annular cavity being positioned around said spindle; and
said annular cavity traversing into said body, opposite to said pointed protrusion.

3. The edible spinning top for domesticated animals as claimed in claim 1 comprises:
a hollowing cavity;
said hollowing cavity traversing through said spindle and traversing into said body; and
said hollowing cavity being concentrically positioned with said spindle.

4. The edible spinning top for domesticated animals as claimed in claim 1, wherein said pointed protrusion is a blunted tip.

5. The edible spinning top for domesticated animals as claimed in claim 1, wherein said body and said spindle having rounded edges.

6. The edible spinning top for domesticated animals as claimed in claim 1 comprises ingredients selected from the group consisting of: flour, water, egg, cinnamon and molasses, peanut butter and honey, beef broth and cheese, chicken broth and parsley, and a combination thereof.

7. A method of implementing the edible spinning top for a domesticated animal as claimed in claim 1, the method comprises the steps of:
providing a domesticated animal;
identifying a current location of said domesticated animal;
grasping and twisting said spindle into a cocked position for said edible spinning top;
rapidly rotating said edible spinning top by releasing said spindle from said cocked position; and
alerting said domesticated animal to interact and to consume said edible spinning top as said edible spinning top rapidly rotates about said central axis.

8. The method of implementing the edible spinning top for a domesticated animal, the method as claimed in claim 7 comprises the step of:
directing said edible spinning top towards said current location of said domesticated animal.

9. The method of implementing the edible spinning top for a domesticated animal, the method as claimed in claim 7 comprises the step of:
directing said edible spinning top away from said current location of said domesticated animal.

10. An edible spinning top for domesticated animals comprises:
a spindle;
a body;
a pointed protrusion;
an annular cavity;
a hollowing cavity;
said body being radial symmetric about a central axis;
said spindle being connected adjacent to said body;
said pointed protrusion being connected adjacent to said body, opposite to said spindle;
said spindle and said pointed protrusion being positioned along said central axis;
said spindle, said body, and said pointed protrusion being made of an edible, desiccated, and brittle composition;
said annular cavity being positioned around said spindle;
said annular cavity traversing into said body, opposite to said pointed protrusion;
said hollowing cavity traversing through said spindle and traversing into said body; and
said hollowing cavity being concentrically positioned with said spindle.

11. The edible spinning top for domesticated animals as claimed in claim 10, wherein said pointed protrusion is a blunted tip.

12. The edible spinning top for domesticated animals as claimed in claim 10, wherein said body and said spindle having rounded edges.

13. The edible spinning top for domesticated animals as claimed in claim 10 comprises ingredients selected from the group consisting of: flour, water, egg, cinnamon and molasses, peanut butter and honey, beef broth and cheese, chicken broth and parsley, and a combination thereof.
